(19) United States
(12) Patent Application Publication
(10) Pub. No.: US 2023/0400948 A1
(43) Pub. Date: Dec. 14, 2023

(54) IMPROVED TOUCH-SENSING APPARATUS

(71) Applicant: FLATFROG LABORATORIES AB, Lund (SE)

(72) Inventors: Håkan BERGSTRÖM, Lund (SE); Tomas SVENSSON, Limhamn (SE)

(21) Appl. No.: 18/249,707

(22) PCT Filed: Nov. 17, 2021
(86) PCT No.: PCT/SE2021/051151

§ 371 Date: Apr. 19, 2023

(30) Foreign Application Priority Data
Nov. 17, 2020 (SE) 2030342-6

(51) Int. Cl. G06F 3/042

(52) U.S. Cl. CPC G06F 3/0421

(57) ABSTRACT

A touch sensing apparatus is disclosed comprising a panel that defines a touch surface extending in a plane having a normal axis, a plurality of emitters and detectors arranged along a perimeter of the panel, a light directing portion arranged adjacent a panel side of the panel, the panel side extending in a longitudinal direction along the perimeter, perpendicular to the normal axis, the light directing portion comprising a light directing surface, wherein the emitters are arranged to emit light and the light directing surface is arranged to receive the emitted light and direct the light across the touch surface, and wherein an optical axis (A) of the emitted light is at an angle from the normal axis so that a vector component (A_{y}) of the optical axis is greater than zero in the longitudinal direction of the panel side.

### TECHNICAL FIELD

The present invention pertains to touch-sensing apparatus that operate by propagating light above a panel. More specifically, it pertains to optical and mechanical solutions for controlling and tailoring the light paths above the panel via fully or partially randomized refraction, reflection or scattering.

### BACKGROUND ART

In one category of touch-sensitive panels known as ‘above surface optical touch systems’, a set of optical emitters are arranged around the periphery of a touch surface to emit light that is reflected to travel and propagate above the touch surface. A set of light detectors are also arranged around the periphery of the touch surface to receive light from the set of emitters from above the touch surface. I.e. a grid of intersecting light paths are created above the touch surface, also referred to as scanlines. An object that touches the touch surface will attenuate the light on one or more scanlines of the light and cause a change in the light received by one or more of the detectors. The location (coordinates), shape or area of the object may be determined by analyzing the received light at the detectors.

Optical and mechanical characteristics of the touch-sensitive apparatus affects the scattering of the light between the emitters/detectors and the touch surface, and the accordingly the detected touch signals. For example, the width of the scanlines affects touch performance factors such as detectability, accuracy, resolution, and the presence of reconstruction artefacts. Problems with previous prior art touch detection systems relate to sub-optimal performance with respect to the aforementioned factors. Some prior art systems aim to improve the accuracy in detecting small objects. This in turn may require incorporating more complex and expensive opto-mechanical modifications to the touch system, such as increasing the number of emitters and detectors, to try to compensate for such losses. This results in a more expensive and less compact system.

### SUMMARY

An objective is to at least partly overcome one or more of the above identified limitations of the prior art.

One objective is to provide a touch-sensitive apparatus based on “above-surface” light propagation which is compact, less complex, robust, while allowing for improved resolution and detection accuracy of small objects.

Another objective is to provide an “above-surface”-based touch-sensitive apparatus with efficient use of light.

One or more of these objectives, and other objectives that may appear from the description below, are at least partly achieved by means of touch-sensitive apparatuses according to the independent claims, embodiments thereof being defined by the dependent claims.

According to a first aspect, a touch sensing apparatus is provided comprising a panel that defines a touch surface extending in a plane having a normal axis, a plurality of emitters and detectors arranged along a perimeter of the panel, a light directing portion arranged adjacent a panel side of the panel, the panel side extending in a longitudinal direction along the perimeter, perpendicular to the normal axis, the light directing portion comprising a light directing surface, wherein the emitters are arranged to emit light and the light directing surface is arranged to receive the emitted light and direct the light across the touch surface, and wherein an optical axis (A) of the emitted light is at an angle from the normal axis so that a vector component (A_{y}) of the optical axis is greater than zero in the longitudinal direction of the panel side.

Some examples of the disclosure provide for a touch sensing apparatus with a more uniform coverage of scanlines across the touch surface.

Some examples of the disclosure provide for a touch sensing apparatus with improved resolution and detection accuracy of small objects.

Some examples of the disclosure provide for a touch sensing apparatus that has a better signal-to-noise ratio of the detected light.

Some examples of the disclosure provide for a touch sensing apparatus with less detection artifacts.

Some examples of the disclosure provide for a touch sensing apparatus with a reduced number of electro-optical components.

Some examples of the disclosure provide for a touch sensing apparatus that is less costly to manufacture.

Some examples of the disclosure provide for a more compact touch sensing apparatus.

Some examples of the disclosure provide for a more robust touch sensing apparatus.

Some examples of the disclosure provide for a touch sensing apparatus that is more reliable to use.

Still other objectives, features, aspects and advantages of the present disclosure will appear from the following detailed description, from the attached claims as well as from the drawings.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF DRAWINGS

These and other aspects, features and advantages of which examples of the invention are capable of will be apparent and elucidated from the following description of examples of the present invention, reference being made to the accompanying drawings, in which;

FIG. 1 is a schematic illustration of a touch sensing apparatus, in a cross-sectional side view seen in a x-z plane, according to one example of the disclosure;

FIG. 2 is a schematic illustration of the touch sensing apparatus in FIG. 1, in a cross-sectional side view seen in a y-z plane, according to one example of the disclosure;

FIGS. 3a-b are schematic illustrations of a touch-sensing apparatus, in top-down views seen in a x-y plane, according to examples of the disclosure;

FIG. 4a is a schematic illustration, in a cross-sectional side, of a touch-sensing apparatus according to one example of the disclosure;

FIG. 4b is a schematic illustration, in a top-down view, of a touch sensing apparatus according to one example of the disclosure;

FIG. 5a is a schematic illustration of a detail of a touch sensing apparatus, in the cross-sectional side view of FIG. 2, seen in a y-z plane, according to one example of the disclosure;

FIG. 5b-c are schematic illustrations of details of a touch sensing apparatus, in a cross-sectional side view seen in a y-z plane, according to examples of the disclosure;

FIG. 6 is a schematic illustration, in a cross-sectional side, of a touch-sensing apparatus, according to one example of the disclosure;

FIG. 7 is a schematic illustration, in a cross-sectional side, of a touch-sensing apparatus, according to one example of the disclosure;

FIG. 8 is a diagram showing the amount of emitted light in the different angles (φ) in the plane of the touch surface for a pair of angled emitters, individually and aggregated;

FIG. 9 is a diagram showing relative useable intensity, for different emitter configurations, as function of the angle (φ) in the plane of the touch surface;

FIGS. 10a-b are schematic illustrations of light scattering against different diffusively reflecting materials that redistributes light in different ways;

FIGS. 11a-b are schematic illustrations of a touch-sensing apparatus, in top-down views seen in a x-y plane, according to examples of the disclosure;

FIGS. 12a-d are schematic illustrations of a touch-sensing apparatus, in top-down views seen in a x-y plane, according to examples of the disclosure.

FIG. 13 is a schematic illustration of a touch-sensing apparatus, in top-down views seen in a x-y plane, according to examples of the disclosure.

### DETAILED DESCRIPTION OF EXAMPLE EMBODIMENTS

In the following, embodiments of the present invention will be presented for a specific example of a touch-sensitive apparatus. Throughout the description, the same reference numerals are used to identify corresponding elements.

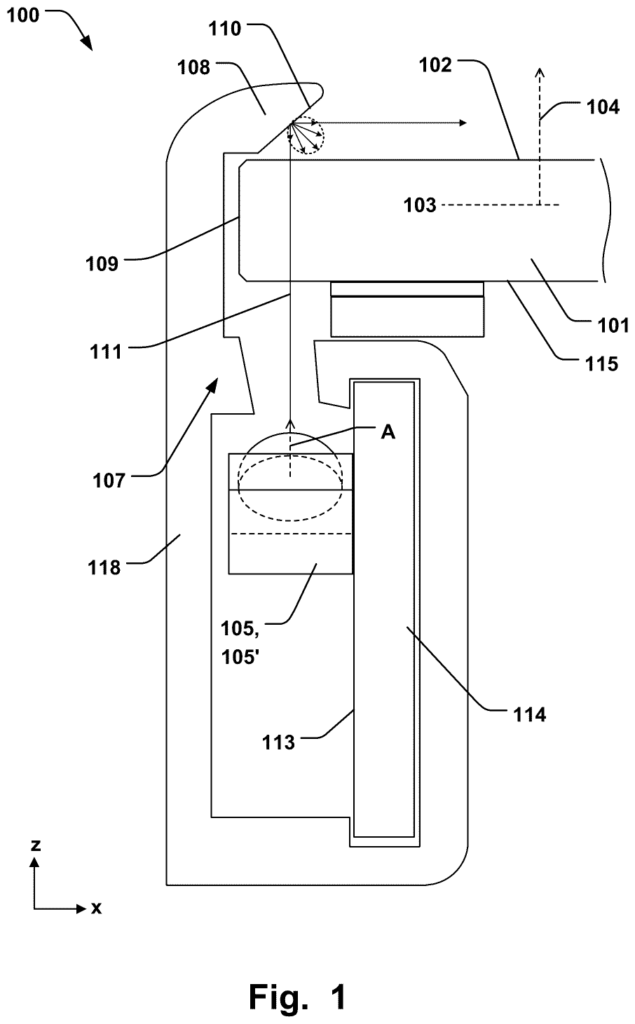

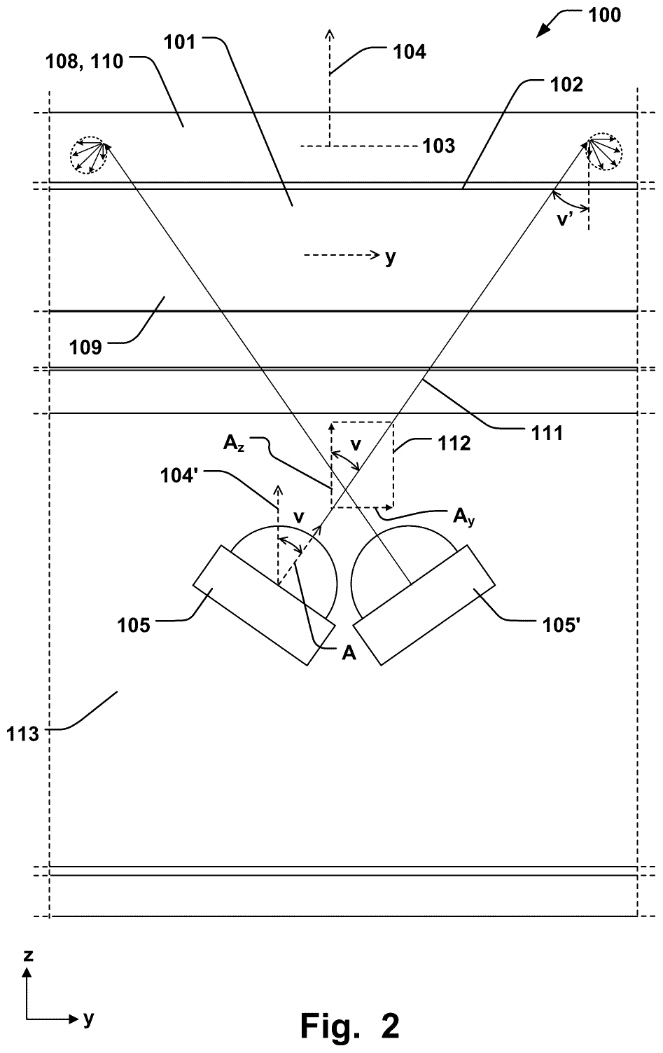

FIG. 1 is a schematic illustration of a touch-sensing apparatus 100 comprising a panel 101 that defines a touch surface 102 extending in a plane 103 having a normal axis 104. FIGS. 2-7 are further schematic illustrations of a touch-sensing apparatus 100. A cartesian coordinate system with orthogonal x-, y-, z-axes, are indicated in the figures to relate the cross-sectional and top-down views of FIGS. 1-7 to each other.

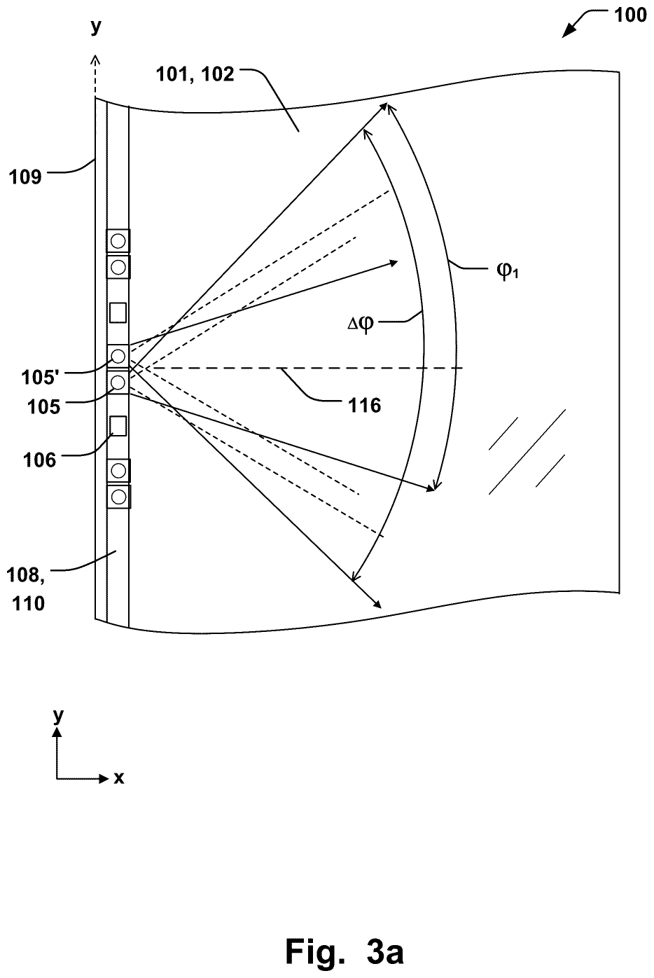

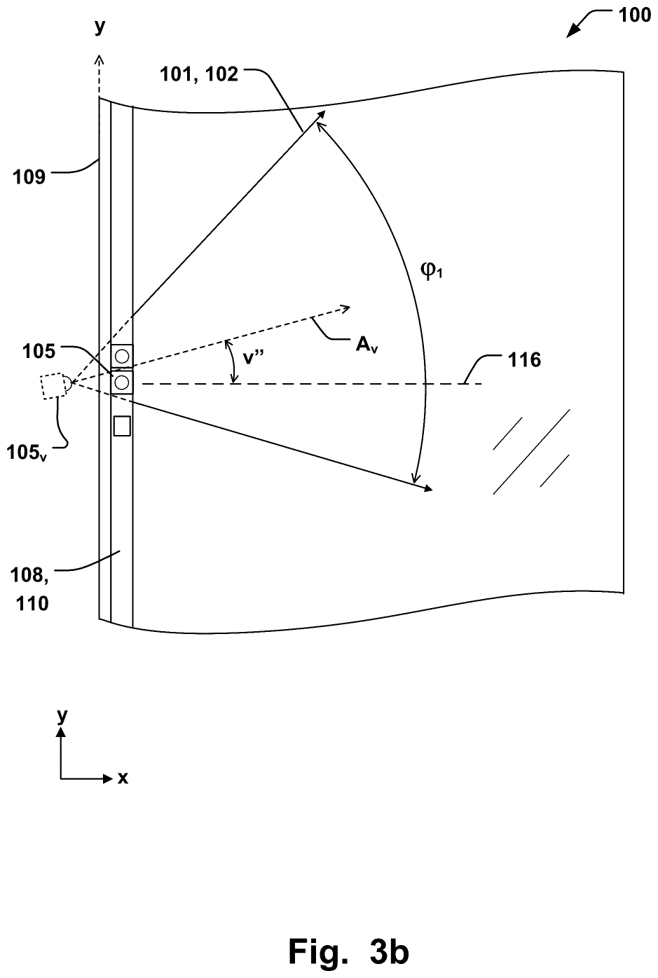

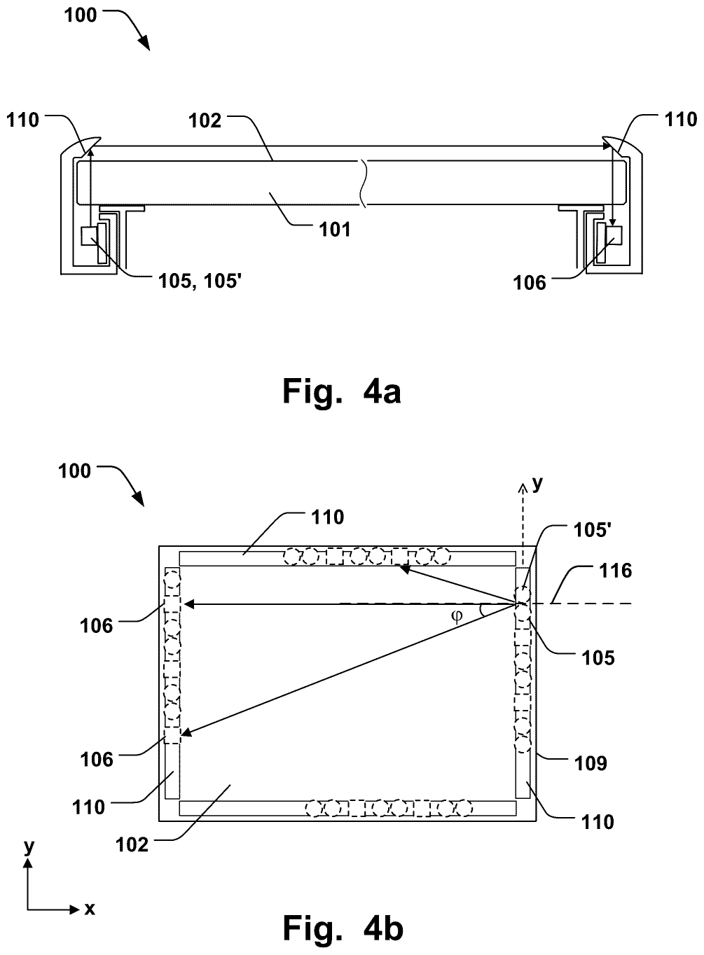

The panel 101 is a light transmissive panel. The touch-sensing apparatus 100 comprises a plurality of emitters 105, 105′, and detectors 106 arranged along a perimeter 107 of the panel 101. FIGS. 1-2 show only emitters, denoted with reference numerals 105 and 105′, for clarity of presentation, while FIGS. 4a-b illustrate how light is transmitted from emitters 105, 105′, to detectors 106 across the touch surface 102 in a cross-sectional side view (FIG. 4a) and in a top-down view (FIG. 4b). The touch-sensing apparatus 100 comprises a light directing portion 108 arranged adjacent a panel side 109 of the panel 101. The panel side 109 extends in a longitudinal direction (y) along the perimeter 107, perpendicular to the normal axis 104, as further illustrated in the top-down views of FIGS. 3, 4b, and the cross-sectional view of FIG. 2. The panel 101 comprises four panel sides 109, where the pairs of opposing sides 109 extend along the y-axis and the x-axis respectively, see e.g. FIG. 4b. The disclosure refers to a side 109 extending along the y-axis, i.e. along a longitudinal direction (y), for brevity. It should be understood that the disclosed features could be implemented along any of the opposing sides 109 extending along the x- and y-axes. The light directing portion 108 comprises a light directing surface 110. The emitters 105, 105′, are arranged to emit light 111 and the light directing surface 110 is arranged to receive the light 111 and direct the light across the touch surface 102 of the panel 101. The light is reflected to detectors 106, after propagating across the touch surface 102, via a corresponding light directing surface 110, as illustrated in e.g. FIG. 4a.

An optical axis (A) of the emitted light 111 is at an angle (v, v₁, v₂) from the normal axis 104 so that a vector component (A_{y}) of the optical axis (A) is greater than zero in the longitudinal direction (y) of the panel side 109, as schematically shown in the example of FIG. 2. The axis indicted with reference numeral 104′ is parallel with the normal axis 104. Arranging the optical axis (A) at an angle (v, v₁, v₂) from the normal axis 104 to obtain a vector component (A_{y}) of the optical axis (A) in the longitudinal direction (y) allows for optimizing the light distribution emitted into the plane 103 of the touch surface 102. For example, the light distribution may be shifted towards angles (φ) in the plane 103 where signals are typically weaker and which limits touch performance. FIG. 4b shows the angle φ in the plane 103 relative an axis 116 perpendicular to the longitudinal direction (y). For example, the signal may be weaker in directions on the touch surface 102 corresponding to an increased angle φ. This may thus be compensated by arranging the optical axis (A) at an angle (v, v₁, v₂) from the normal axis 104.

FIG. 3b shows an example where the light from emitter 105 is scattered over an angle (Φ₁) across the touch surface 102. The optical axis (A) of the light 111 emitted by the emitter denoted 105 in FIG. 2 is at an angle (v) from the normal axis 104, so that the optical axis (A) has a vector component (A_{y}) as indicated in FIG. 2. The angle of incidence (v′) of the emitted light on the light directing surface 110 may thereby be varied. The light is reflected at an angle (v″), as schematically indicated in the top-down view of FIG. 3b, in dependence on the angle of incidence (v′) on the directing surface 110. FIG. 3b illustrates an extension of an optical axis (Aᵥ) of the emitted light when extended from a virtual representation 105v of the light source, i.e. the emitter 105. An axis 116 perpendicular to the longitudinal direction (y) is included for reference. The light is scattered over an angle (φ₁) across the touch surface 102. The light directing surface 110 thus scatters the light along the indicated optical axis (Aᵥ) at angles typically dependent on the angle of incidence on the directing surface 110. This provides for obtaining an asymmetrical light distribution in the plane 103 with respect to the axis 116 perpendicular to the longitudinal direction (y), as exemplified in FIG. 3b by the light scattered over the angle φ₁ relative axis 116.

The top-down view of the touch surface 102 in FIG. 3a is a further schematic illustration of such example where the light distribution from the emitter denoted with reference numeral 105 is asymmetrical with respect to the aforementioned axis 116. The light from emitter 105 is scattered over an angle (φ₁). In this case, the angle of incidence (v′) of the emitted light on the light directing surface 110 has been increased, as exemplified in FIG. 2, to obtain such asymmetrical distribution. A symmetrical light distribution in the plane 103 is showed with dashed lines in FIG. 3a for reference, corresponding to the case when the optical axis (A) of the emitted light 111 is parallel with the normal axis 104, i.e. when the angle of incidence (v′) is essentially zero in the y-z plane of FIG. 2.

The distribution and coverage of the light paths reflected across the touch surface 102, i.e. the scanlines, which are available for the touch detection, may thus be increased in desired directions (φ) across the touch surface 102 to optimize the touch signal as different objects (not shown) interact with the touch surface 102 at different locations. The coverage may be increased both due to an increase in the angle of coverage in φ, and due to an effectively broader scanline width. The enhanced and optimized scanline coverage allows for a more effective utilization of the contribution to the touch signal from each emitter 105 and/or detector 106. The signal to noise ratio is effectively increased. This in turn means that the number of emitters 105 and/or detectors 106 per site, which may be construed as component density, may be decreased. At least part of an overlapping coverage of the scanlines obtained from a symmetrical directionality (as exemplified by the dashed lines across the touch surface 102 in FIG. 3a) may thus be replaced by a specifically targeted or wider coverage. The optimized scanline coverage thus provides for reducing the number of emitters 105, 105′, and detectors 106, while allowing for accurate touch detection of objects of reduced size on the touch surface 102. A facilitated control of the directionality and width of the scanlines provides for increasing the accuracy of the touch detection process as the amount of detection light available for the touch detection may be optimized over the touch surface 102. The amount of noise can be reduced and the strength of the carrier signal for the touch detection process may be increased. This also provides for lowering the power consumption of the touch sensing apparatus 100, since e.g. the emitter current may be decreased due to the more efficient utilization of the contribution to the touch signal from each emitter 105. Utilizing the available detection light more effectively also enables a greater component flexibility. E.g. emitters 105 and/or detectors 106 with a wider range of characteristics and performance may be used while still providing for an effective touch detection. The touch sensing apparatus 100 may thus be manufactured with a reduced cost.

Lowering the component density also provides for reducing the power consumption of the touch sensing apparatus 100. A less complex touch sensing apparatus 100 may thus be provided, e.g. due to lower current requirements on the components thereof. The improved coverage provides for a more even spread of light in the plane 103. I.e. the difference in intensity at larger angles of p, relative the emitters 105, 105′, compared to the intensity at smaller angles of p may be reduced. This in turn allows for optimizing and reducing the current supply to the emitters 105, 105′, with less risk of having areas in the plane 103 where the intensity go below a desired threshold. The cost of the touch sensing apparatus 100 may be reduced. The number of components needing alignment is thus also reduced, which simplifies assembly. A particularly compact and robust touch-sensing apparatus 100 is thus provided, with more efficient use of detection light. Touch detection performance may thus be increased, while reducing complexity and costs.

Providing an asymmetrical coverage as described above further allows for accommodating a wider range of geometries of the panel 101 and touch surface 102. For example, the aspect ratio of the panel 101 may be increased, e.g. by increasing the length of the sides 109 parallel with the x-axis and/or reducing the length of the sides 109 parallel with the y-axis, while maintain scanline coverage across the panel 101 by varying the angle (v, v₁, v₂). In high-aspect ratio geometries, the detectors 106 may advantageously be arranged with an angle (v, v₁, v₂) with respect to the normal axis 104, analogous to what is described above with reference to optical axis (A). This provides for accommodating the increased angle (φ) of light distribution required in such geometries, and thus allowing for improved touch detection.

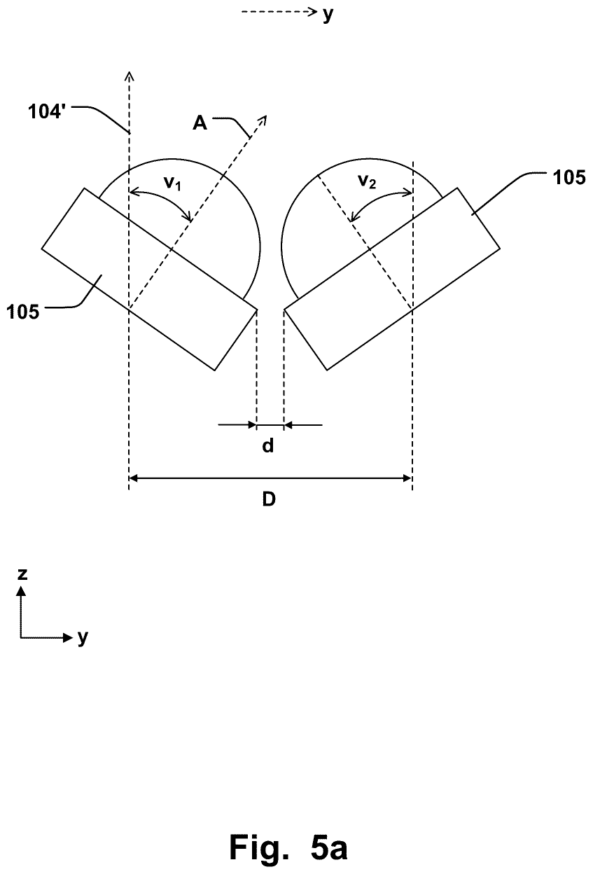

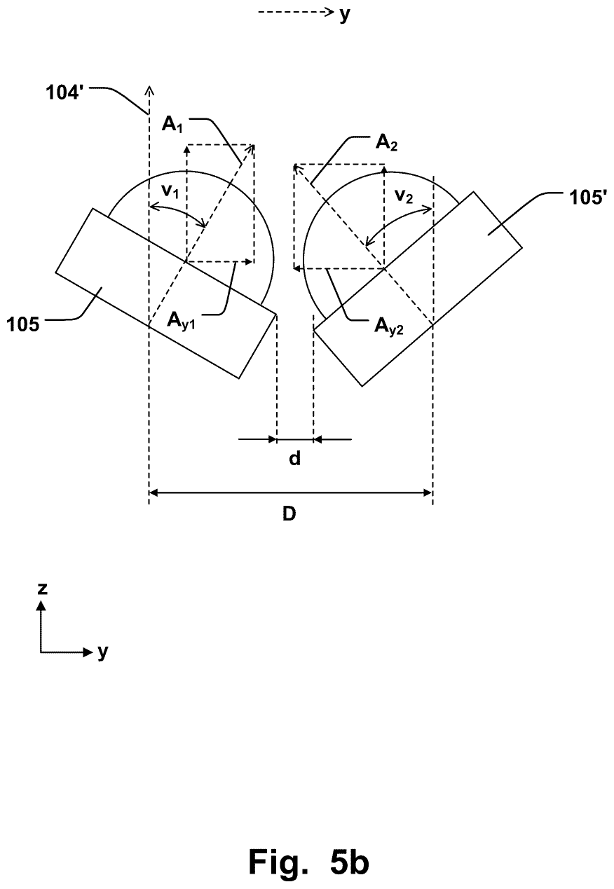

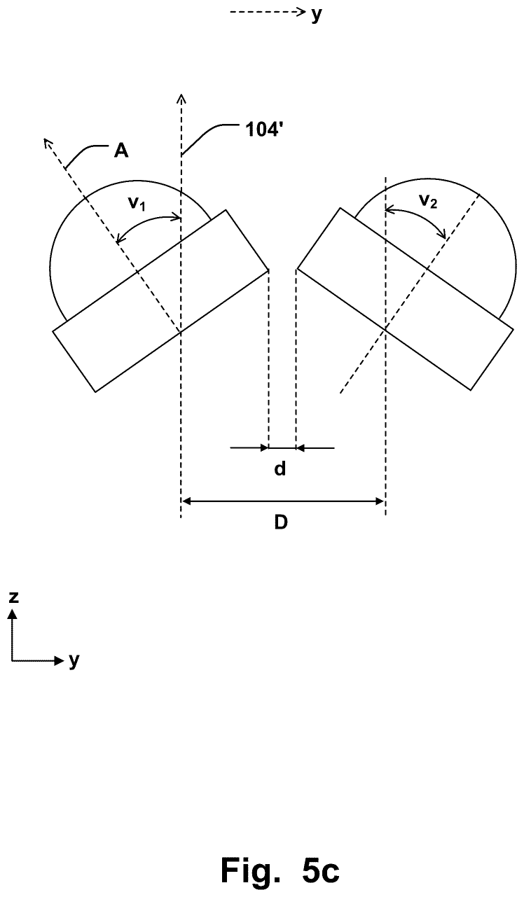

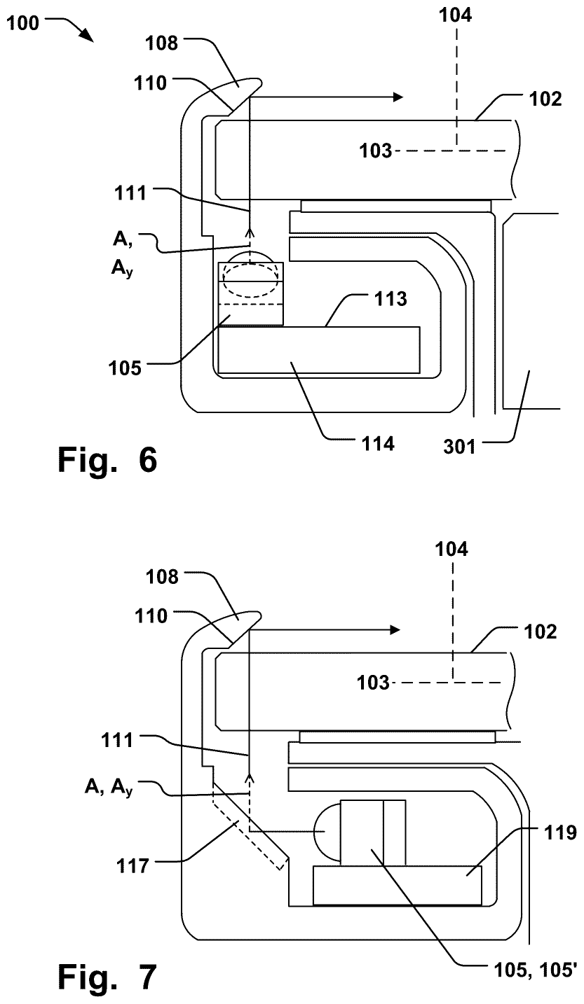

An emitter 105, 105′, of the plurality of emitters may be arranged at said angle (v, v₁, v₂) from the normal axis 104 so that the vector component (A_{y}) of the optical axis (A) is greater than zero in the longitudinal direction (y), as schematically illustrated in e.g. FIGS. 1-2, 5a-c, and FIG. 6. Such tilting of the emitter 105, 105′, along the direction of the longitudinal axis (y) provides for effectively changing the direction of the optical axis (A) of the light 111 emitted by the emitter 105, 105′. The optical axis of the emitter 105, 105′, may thus in this example correspond to the optical axis (A). The light distribution in the plane 103, represented by angle (φ₁) in FIG. 3a, and scanline coverage may be effectively improved as elucidated above. FIGS. 2 and 5a-c show examples of having a first and second emitter 105, 105′, arranged at an angle (v, v₁, v₂) from the normal axis 104. It should be understood that the first and second emitters 105, 105′, may be arranged at different angles (v₁, v₂), as described further below. It is also conceivable that one of the emitters 105, 105′, is arranged at an angle (v, v₁, v₂), while the other one of the emitters 105, 105′, is arranged essentially in parallel with the normal axis 104. The light emitted from the latter may thus have an optical axis (A) essentially in parallel with the normal axis 104. Further, any plurality of emitters 105, 105′, along the sides 109 of the panel 101, may be arranged at an angle (v, v₁, v₂) from the normal axis 104 to optimize the light distribution in the plane 103, in the direction of the angle φ, depending on the particular touch application and/or geometry of the panel 101. The angled emitters 105, 105′, may be arranged in pairs as described further below.

FIG. 7 show an example where the optical axis (A) of the emitted light 111 is angled by a reflector surface 117 arranged in the light path of the emitter 105, 105′. The reflector surface 117 may thus be arranged at an angle so that the optical axis (A) of the emitted light is at an angle (v, v₁, v₂) from the normal axis 104 to obtain a vector component (A_{y}) which is greater than zero in the longitudinal direction (y) of the panel side 109. This provides for the advantageous benefits as described above with reference to e.g. FIGS. 1-2. An improved scanline coverage may thus be provided. The reflector surface 117 may be tilted along the longitudinal direction (y). The reflector surface 117 may be arranged at the aforementioned angle (v, v₁, v₂) from the normal axis 104 in one example. The emitter 105, 105′, may be arranged so that light is emitted towards the reflector surface 117 essentially in parallel with the plane 103, as schematically illustrated in FIG. 7.

The angle (v, v₁, v₂) from the normal axis 104 may be defined in the plane 112 spanned by the normal axis 104 and the longitudinal direction (y), as schematically indicated in FIG. 2. The angle (v, v₁, v₂) may form an acute angle with the normal axis 104, as further exemplified in e.g. FIG. 2. The angle (v, v₁, v₂) may be in the range 20-45 degrees. This provides for an advantageous light distribution in the plane 103 with wide scanline coverage.

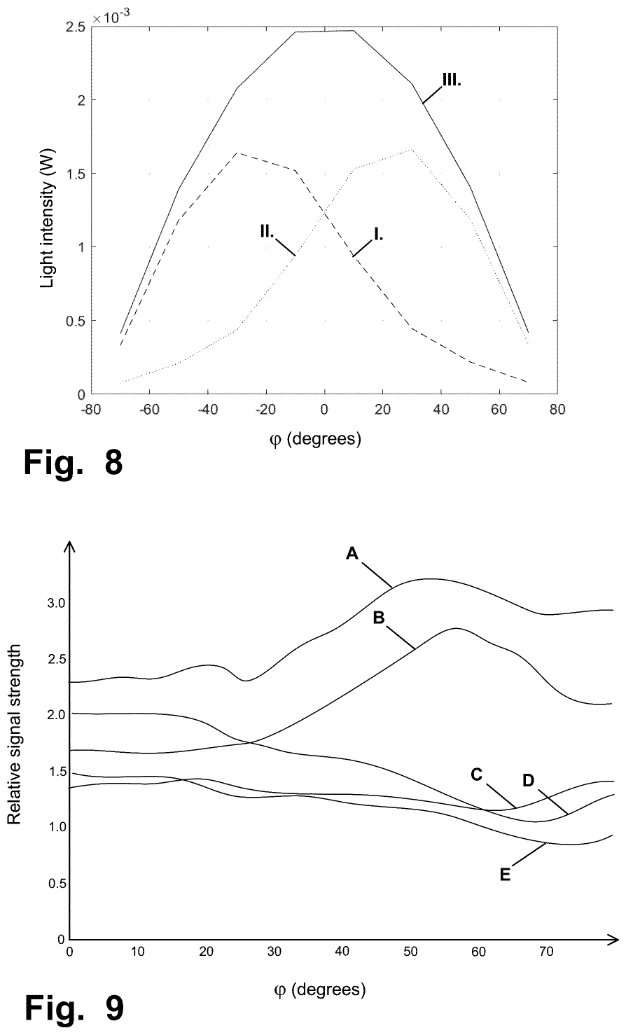

The touch sensing apparatus 100 may comprise pairs of emitters 105, 105′, arranged side-by-side, as exemplified in the cross-sectional views of FIGS. 2, 5a-c, and the top-down view of FIG. 3a. The pairs of emitters 105, 105′, may comprise a first emitter 105 arranged at a first angle (v₁) from the normal axis 104, and a second emitter 105′ arranged at a second angle (v₂) from the normal axis 104. Having pairs of angled emitters 105, 105′, along the sides 109 provides for effectively controlling the width of the scanlines to optimize the coverage across the touch surface 102. FIG. 3a shows an example where a pair of angled emitters 105, 105′, are arranged to provide an increased light distribution in the plane 102 (i.e. a broader distribution resulting from the sum of the contributions from emitters 105, 105′, represented by Δ_{φ} in FIG. 3a), compared to the case of having the optical axis (A) of the emitted light 111 in parallel with the normal axis 104, corresponding to the dashed lines in FIG. 3a. FIG. 8 is a diagram showing the amount of emitted light in the plane 102, in the direction of angle φ, for a pair of angled emitters 105, 105′, having respective light intensity curves I and II, as well as the aggregated intensity represented by III. Having pairs of angled emitters 105, 105′, provides for using individual emitters 105 in the manufacturing of the touch sensing apparatus 100 of a wider range of characteristics and performance since the summed contribution from the two angled emitters 105, 105′, in the pair can amount to a sufficiently strong touch detection signal. This provides in some examples for reducing the cost of the manufacturing of the touch sensing apparatus 100, since lack of performance of the individual emitters 105, 105′, may be mitigated by having the respective emitters 105, 105′, angled in pairs as described above.

The first and second angles (v₁, v₂) may be essentially the same but oppositely directed with respect to the normal axis 104, as exemplified in FIGS. 5a and 5c. The asymmetric light distribution from the individual first and second emitters 105, 105′, with respect to axis 116 (FIG. 3a), may thus be combined into an essentially symmetrical light distribution from the pair emitters 105, 105′. This may provide for an advantageous scanline coverage in some applications of the touch sensing apparatus 100.

The first and second emitters 105, 105′, may be angled towards each other, as schematically illustrated in the examples of FIGS. 2 and 5a-b. Tilting the first and second emitters 105, 105′, towards each other along the longitudinal direction (y) provides in some examples for improving the scanline coverage, such as in areas along the perimeter 107 of the panel 101 and inbetween the positions of the first and second emitters 105, 105′, along the side 109. FIG. 9 is a diagram showing a relative signal strength of touch signals (A-B) detected as function of the angle (φ) in the plane 103 relative the light source (e.g. as seen in FIG. 4b). The touch signals indicated with A and B correspond to example configurations of pairs of first and second emitters 105, 105′, where the first and second emitters 105, 105′, are arranged with an angle (v, v₁, v₂) towards each other. The touch signals indicated with C-E correspond to example configurations where the emitters 105, 105′, are arranged so that the optical axis (A) of the emitted light 111 is parallel with the normal axis 104. Thus, as shown in the example of FIG. 9, the touch signal may be increased by tilting the emitters 105, 105′, along the longitudinal direction (y).

The first and second angles (v₁, v₂) may be different so that the respective vector components (A_{y1}, A_{y2}) of the optical axes (A₁, A₂) in the longitudinal direction (y) are different for the first and second emitters 105, 105′. FIG. 5b shows an example where the first and second emitters 105, 105′, are arranged with different angles (v₁, v₂) relative the normal axis 104. Having the emitters 105, 105′, tilted with different angles (v₁, v₂) may be advantageous in some applications and configurations of the touch-sensing apparatus 100. The difference between the angles (v₁, v₂) may depend on the position of the pair of emitters 105, 105′, along the side 109. For example, consider a panel 101 with opposing pair of sides 109 extending along the respective x- and y-axes. An emitter, such as the emitter denoted 105 along the y-axis in FIG. 3a, may be arranged at an angle (v) along the longitudinal direction (y) as described above in relation to FIGS. 1 and 2. Turning again to the top-down views of FIGS. 3a and 4b, the emitter 105 may thus be tilted in a direction towards an adjacent side 109 extending along the x-axis, perpendicular to the y-axis of the side where the emitter 105 is placed. The angle (v) of the emitter 105 may vary in dependence on its position relative the adjacent perpendicular side 109 extending along the x-axis. For example, the angle (v) of the emitter 105 may be reduced as the distance between the emitter 105 and the adjacent longitudinal side 109 (extending along the x-axis) decreases. The directionality of the light originating from said emitter 105 may thus be controlled such that a greater portion of the light is directed towards the center of the plane 103 instead of the longitudinal side 109 extending along the x-axis. In the example of FIG. 3a, this would correspond to turning (clock-wise) the angle of light distribution (φ₁) of the emitter denoted with reference numeral 105 more towards the direction of light distribution of the adjacent emitter, denoted with reference numeral 105′. The second emitter 105′ may at the same time be arranged at a second angle (v₂), different from the angle (v, v₁) of the first emitter 105.

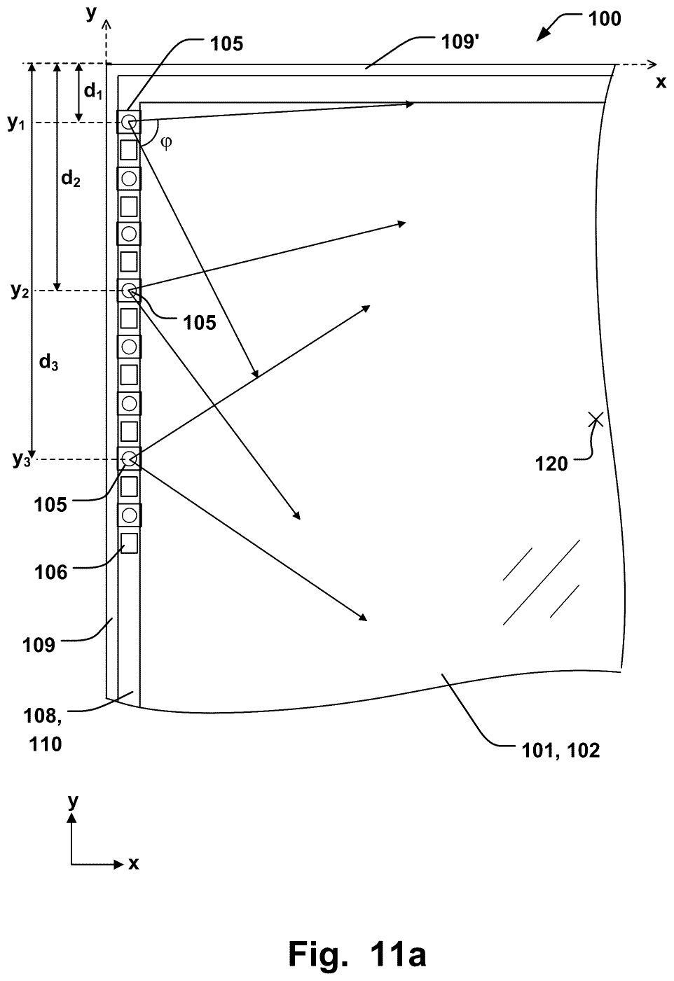

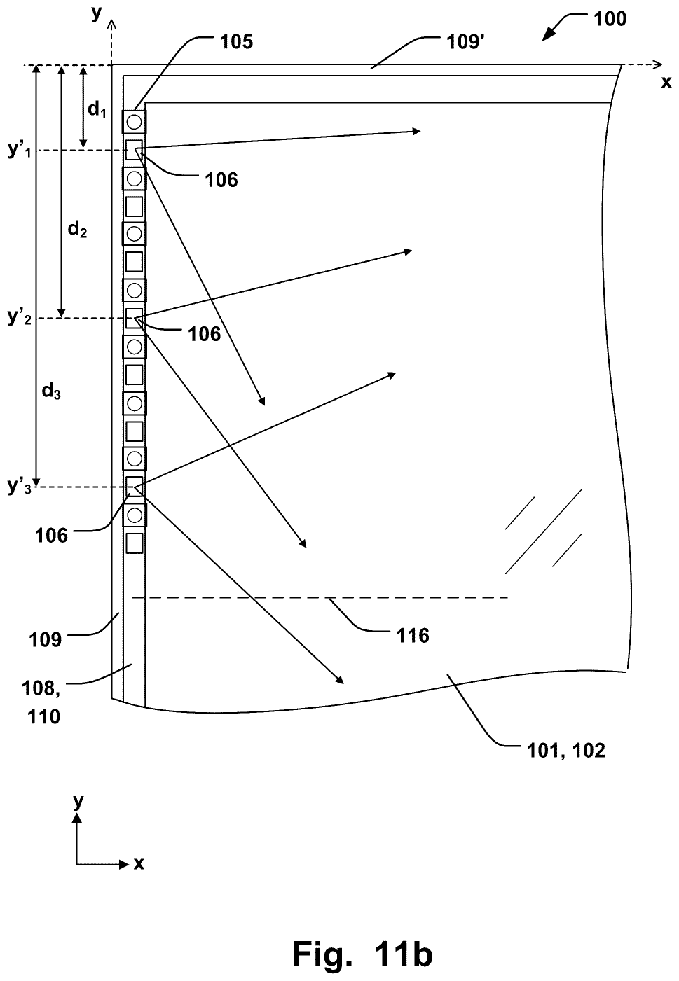

FIG. 11a shows a further example where the angle of light distribution y depends on the position of the respective emitter 105 along the longitudinal direction (y) of a first side 109 of the panel 101. Accordingly, the angle (v) of an emitter 105, as described above with respect to FIGS. 2, 3a-b, varies in along the longitudinal direction (y), i.e. dependence on the position of the emitter 105 relative the adjacent perpendicular side 109′ extending along the x-axis. The angle (v) of the optical axis (A) of the emitter 105 affects the reflection angles (v′ and v″) as described above with reference to FIG. 3b. The light distribution in the plane 103 of the touch surface 102, described by the angle φ, is accordingly controlled and varied in dependence on the position (y₁, y₂, y₃) of the emitter 105 along the longitudinal direction (y). The angle (v, v₁, v₂) of the optical axis (A) of light emitted by a first emitter 105 of the plurality of emitters may thus be based on the position (y₁, y₂, y₃) of the first emitter 105 along the longitudinal direction (y) of the panel side 109.

In one example the angle (v, v₁, v₂) increases as a distance (d₁, d₂, d₃) between the position (y₁, y₂, y₃) of the first emitter 105 along a first panel side 109 and a second panel side 109′ is reduced. The second panel side 109′ is arranged perpendicular to the first panel side 109. FIG. 11a is a schematic illustration of such example, where the angle (v) of emitters 105 along a first panel side 109 is varied so that the light distribution (φ) is turned towards a center point 120 of the touch surface 102. The angle of the emitters 105 increase as the distance is reduced between the respective emitter 105 and the second panel side 109′. The optical axis (A) of the light from the emitter 105 at y₁ is thus tilted with a larger angle (v) compared to the optical axis (A) of the light from the emitter 105 at y₂ or y₃. The asymmetric orientation of the emitters 105 near the corners of the panel sides 109, 109′, may thus be utilized to further optimize the distribution and coverage of the light paths reflected across the touch surface 102, i.e. the scanlines, which are available for the touch detection. In the example of FIG. 11a the light distribution (y) is advantageously turned towards the center point 120 with an amount that still provides reflected light along the second panel side 109′ and touch detection along the perimeter 107 of the second panel side 109′.

The angle (v, v₁, v₂) of the detectors 106 may also be based on the position (y′₁, y′₂, y′₃) of the respective detectors 106 along the longitudinal direction (y) of the panel side 109, as schematically illustrated in the example of FIG. 11b. The angle (v, v₁, v₂) may increase as a distance (d₁, d₂, d₃) between the position (y′₁, y′₂, y′₃) of the detector 106 along a first panel side 109 and a second panel side 109′ is reduced. The second panel side 109′ is arranged perpendicular to the first panel side 109.

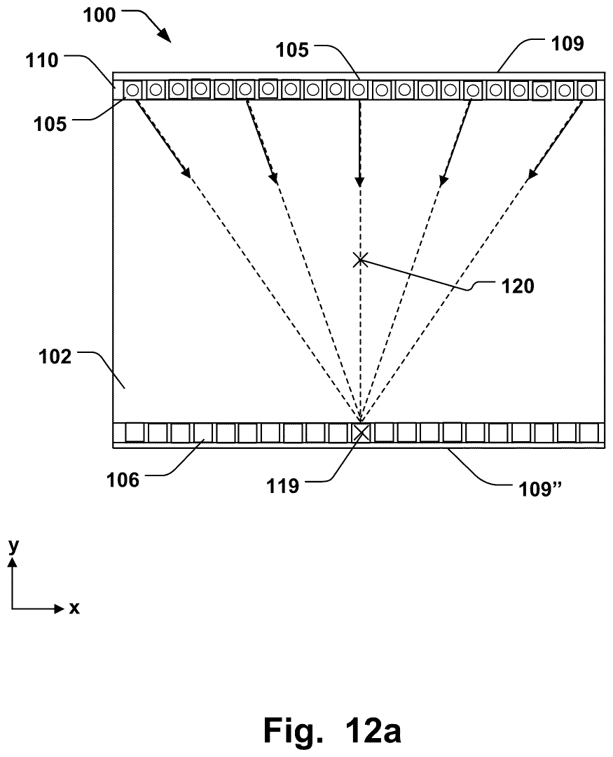

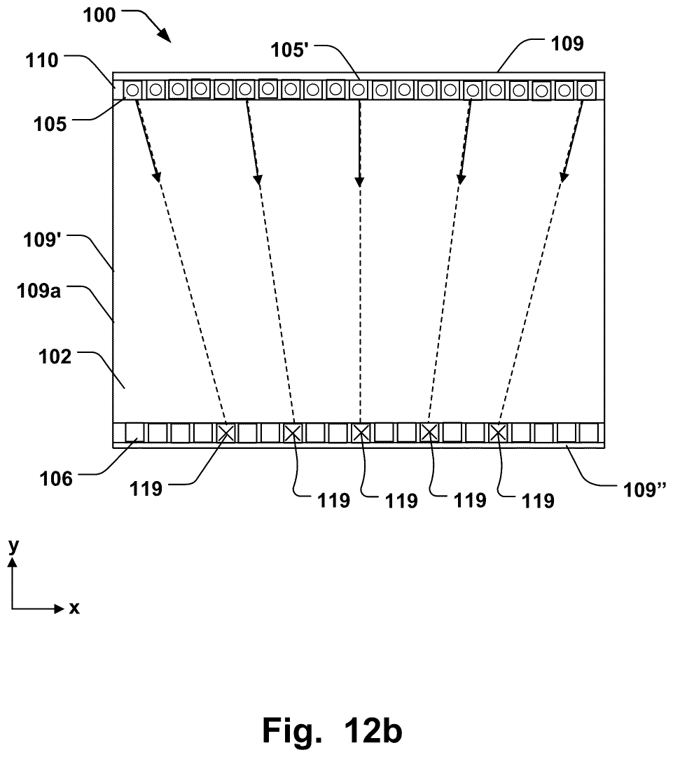

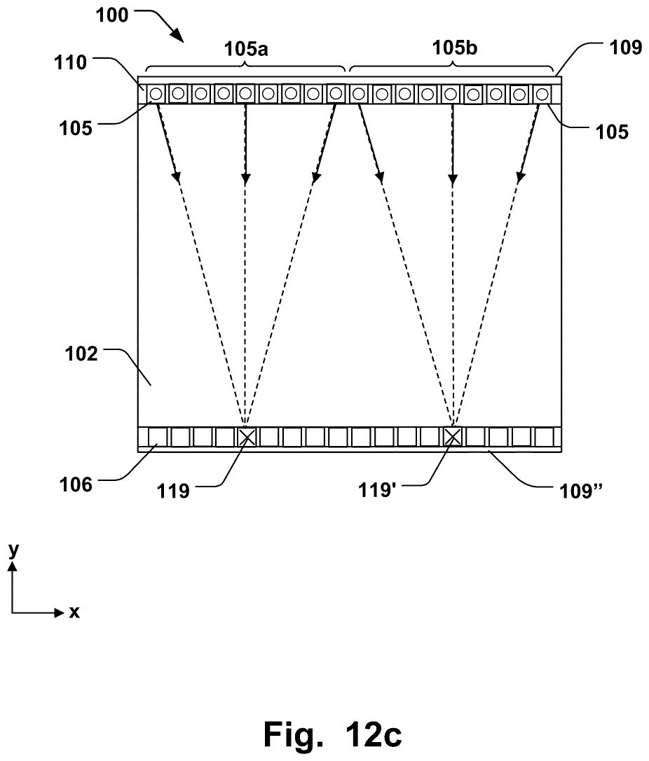

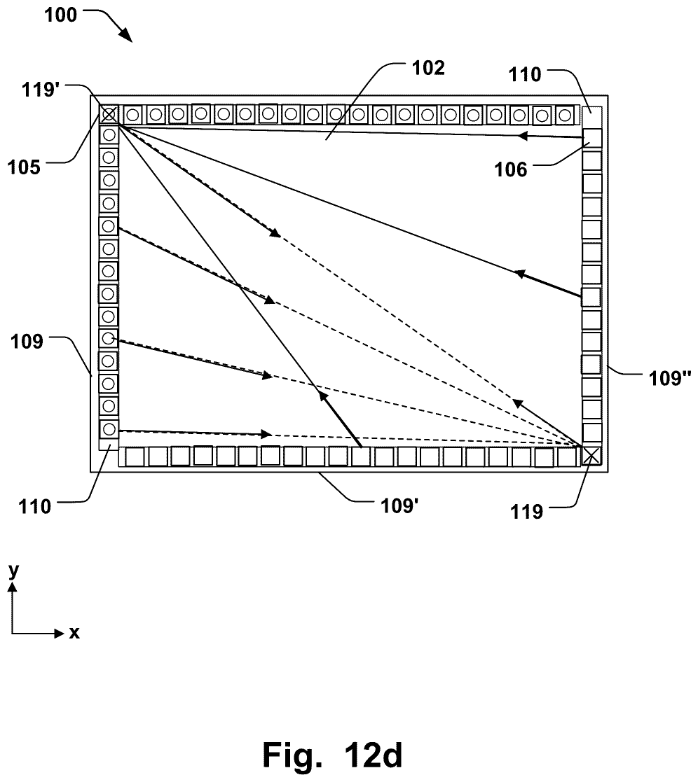

Emitters 105 along a first panel side 109 may be arranged at varying angles (v, v₁, v₂) along the first side 109 so that the emitted light along respective optical axes (A) is directed to at least one common reference point 119, 119′, on the panel 101, as schematically illustrated in FIGS. 12a-d. In the example of FIG. 12a the common reference point 119 is at a mid-point at a third panel side 109″ being is opposite and parallel to the first panel side 109. The emitters 105 along the first panel side 109 are thus angled to direct the light to the reference point 119.

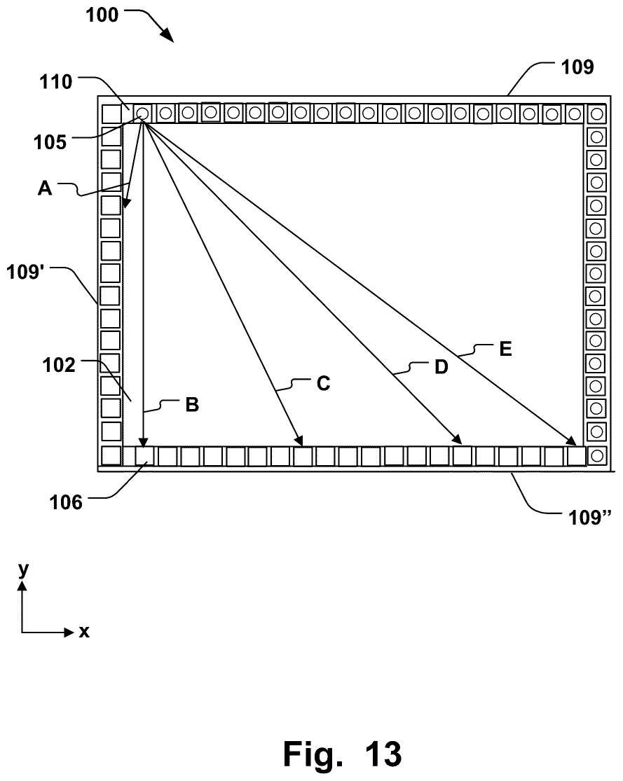

Emitters 105, 105′, along a first panel side 109 may be arranged at varying angles (v, v₁, v₂) along the first side 109 so that the emitted light along respective optical axes (A) is directed to a plurality of reference points 119 located across different positions on the panel 101, as schematically illustrated in FIG. 12b. In the example of FIG. 12b the plurality of reference points 119 are distributed along a third panel side 109″ being is opposite and parallel to the first panel side 109. The direction of each emitter 105 may be optimized depending on its position along the first panel side 109. E.g. for the emitter denoted with reference numeral 105 adjacent to a second side 109′ of the panel 101 a portion of the emitted light can be redistributed towards a reference point 119 along the third panel side 109, where the reference point 119 is arranged further away from the second panel side 109′ than the aforementioned emitter 105. This provides for an effective utilization of the detection light where weaker scan lines can be compensated while maintaining part of the detection light along the second side 109′ for detection close to the edge 109a thereof. The strength of the scan lines typically depend on the length of the detection path. E.g. scan lines A, B and C in the schematic illustration of FIG. 13 are typically stronger than scan lines D and E. Thus, the emitter denoted with reference numeral 105 close to the intersection of sides 109 and 109′, may be arranged at an angle (v, v₁, v₂) to reorient the light distribution further towards the direction corresponding to scan line E. Part of the signal along the A and B directions, and possibly also C, may thus be sacrificed in favor of increasing the signal along the D and E directions. The D and E directions may thus benefit from the stronger signal achieved by arranging of the emitter 105 at an angle (v, v₁, v₂).

In one example a first group of emitters 105a may be directed to a first reference point 119, and a second group of emitters 105b may be directed to a second reference point 119′, as schematically illustrated in FIG. 12c. In the example of FIG. 12c the first and second reference points 119, 119′, are arranged along a third panel side 109″ being is opposite and parallel to the first panel side 109 where the first and second groups 105a, 105b, of emitters 105 are arranged.

The emitters 105 and detectors 106 in FIGS. 12a-c are arranged along the opposing panel sides 109, 109″, but is should be understood that the emitters 105 and detectors 106 may be arranged in other configurations along the panel sides 109, 109″, while providing for the advantageous benefits from varying the light distribution in p via the position dependent angle (v) of the respective emitters 105 and/or detectors 106 along the panel sides 109, 109″.

The common reference point 119 may be at the intersection of a second panel side 109′ and a third panel side 109″, as schematically illustrated in the example of FIG. 12d. The second panel side 109′ extends perpendicular from the first panel side 109, and the third panel side 109″ is opposite and parallel to the first panel side 109. FIG. 12d is an example where the emitters 105 and the detectors 106 are arranged in respective L-configurations around the panel 101. The emitters 105 may thus be angled towards a reference point 119 at the intersection of the sides 109′, 109″, with the detectors 106. This may further provide for optimizing the amount of available the detection light for the touch detection process. In one example the detectors 106 may be angled towards a respective second reference point 119′ at the intersection of the opposing sides of the emitters 105, as further illustrated in FIG. 12d. In one example individual emitters 105 and/or detectors 106 or even pairs of emitters 105 and detectors 106 may be mounted at angles (v) with individually optimized distributions in y, e.g. to illuminate the opposing L-configuration as exemplified in FIG. 12d. It should be understood however that the light distribution may be similarly controlled in other geometries. In one example the p-direction of all scan lines may be selected to maximize the signal strength for the weakest scan line.

The first and second emitters 105, 105′, may be angled towards each other with different angles (v₁, v₂) relative the normal axis 104 as exemplified in FIG. 5b. It is also conceivable that the first and second emitters 105, 105′, may be angled away from each other, with the same angles (v₁, v₂) on opposite sides of the normal axis 104, as exemplified in FIG. 5c, or with different angles (v₁, v₂) on said opposite sides relative the normal axis 104.

The first and second emitters 105, 105′, may be arranged with a separation gap (d), as illustrated in e.g. FIG. 5a. The separation gap (d) may be in the range 0.1-5 mm. The separation gap (d) may be in the range 0.3-1.0 mm in some examples, which may provide a particularly advantageous distribution and coverage of the scanlines over the touch surface 102. The separation gap (d) may be approximately 0.5 mm in one example. The distance (D) between the midpoints of the emitters 105, 105′, as indicated in e.g. FIG. 5a, may be varied to optimize the scanline coverage for various applications. The distance (D) may in some examples be in the range 1-10 mm. The distance (D) may in some examples be in the range 4-7 mm, for a particularly advantageous scanline distribution.

A detector 106 of the plurality of detectors may be arranged at an angle (v, v₁, v₂) from the normal axis 104. I.e. the detector 106 may be tilted along the longitudinal direction (y) as described above with reference to the optical axis (A). This provides for improved detection of light being reflected at increased angles (φ) in the plane 103, as exemplified above with respect to high-aspect ratio geometries of the panel 101. Any plurality of detectors 106 along a side 109 may be arranged an angle (v, v₁, v₂) from the normal axis 104 in order to optimize the light detection in different applications and configurations of the touch sensing apparatus 100. The touch sensing apparatus 100 may comprise pairs of detectors 106, arranged side-by-side, as described with respect to the emitters 105, 105′.

The emitters 105, 105′, may be mounted on a surface 113 of a substrate 114. The surface 113 may be arranged to extend essentially in the direction of the normal axis 104, as schematically illustrated in the example of FIG. 1. I.e. the substrate 114 may extend with an elongated shape in a direction essentially in parallel with the normal axis 104. This allows for a facilitated mounting of the emitters 105, 105′, at a desired angle (v, v₁, v₂) from the normal axis 104, e.g. as seen in the cross-sectional view of FIG. 2. The illustration in FIG. 2 shows the mounting position of the emitters 105, 105′, on the surface 113 in the y-z plane, compared to the mounting position in the x-z plane as exemplified in FIG. 1. Hence, pairs of emitters 105, 105′, may be mounted to the surface 113 with the respective first and second angles (v₁, v₂) from the normal axis 104, as exemplified in FIG. 2. The detectors 106 may accordingly also be mounted on the surface 113 of the substrate 114, e.g. in pairs. Having the surface 113 arranged to extend essentially in the direction of the normal axis 104 provides further for reducing the dimensions of the touch sensing apparatus 100 in the direction perpendicular to the normal axis 104, which may be desirable in some applications where the amount of space in this direction is limited, and/or when the ratio of available touch surface 102 to the surrounding frame components is to be optimized. Having the substrate 113 extending along the direction of the normal axis 104 combined with having the emitters 105 and/or detectors 106 arranged closer to the frame element 118 (as indicated in FIG. 1) than the substrate 114 provides for particularly efficient utilization of space along the direction of the plane 103.

FIG. 6 show an example where the substrate 114 extends along the direction of the plane 103, which provides for achieving compact dimensions along the direction of the normal axis 104. This may be advantageous when utilized in conjunction with particularly flat display panels 301. FIG. 7 is another example where the substrate 114 extends along the direction of the plane 103, but the emitters 105, 105′, and/or detectors 106 are arranged to emit/receive light in the direction of the plane 103 via a reflective surface 117. The reflective surface 117 may be a specular reflective surface.

The light directing portion 108 may comprise a diffusive light scattering element 108, in which case the light directing surface 110 diffusively reflects the light across the touch surface 102. Any of the light directing portions 108 as schematically illustrated in FIGS. 1-4, 6 and 7 may comprise a diffusive light scattering element 108, i.e. a diffusive light directing surface 110.

Arranging the optical axis (A) at an angle (v, v₁, v₂) from the normal axis 104 to obtain a vector component (A_{y}) of the optical axis (A) in the longitudinal direction (y) in combination with having a diffusive light directing surface 110 which spreads light across the plane 103 in dependence on the angle of incidence (v′), as discussed in relation to FIGS. 2, 3a-b, rather than spreading the light along a normal of the light directing surface 110, allows for shifting the light distribution in φ, while providing for an optimized coverage of light in the plane 103 of the touch surface 102. For example, the light distribution may be shifted towards an angle φ where signals are typically weaker and limits touch performance. As described below, a light directing surface 110 having these properties may be implemented via sandblasting and/or anodization of aluminium.

Having a diffusive light scattering element 108 arranged in the path of the light 111 provides for an optimized coverage of light in the plane 103 of the touch surface 102. The position and characteristics of the diffusive light scattering element 108 in relation to the emitters 105, 105′, detectors 106, and the panel 101 may be varied for optimization of the performance of the touch-sensing apparatus 100 to various applications. Further variations are conceivable within the scope of the present disclosure while providing for the advantageous benefits as generally described herein.

The light directing surface 110 may be anodized metal. The light directing surface 110 may also be surface treated to diffusively reflect the light 110 towards the touch surface 102. The surface roughness affects the diffusive scattering. Different surface characteristics may be achieved by various processes, such as etching, sand blasting, bead blasting, machining, brushing, polishing, as well as the mentioned anodization. A diffusive light scattering surface 110 may be implemented as a coating, layer or film applied by e.g. by painting, spraying, lamination, gluing, etc. The diffusive light scattering surface may be matte black. The diffusive light scattering surface may comprise; matte black-, white- or colored paint, matte black-, white- or colored paper, Spectralon, a light transmissive diffusing material covered by a reflective material, diffusive polymer or metal, an engineered diffuser, a reflective semi-random micro-structure, in-molded air pockets or film of diffusive material, different engineered films including e.g. lenticular lenses, or other micro lens structures or grating structures. The diffusive light scattering surface preferably has low NIR absorption. The diffusive light scattering surface may comprise various periodical structures, such as sinusoidal corrugations provided onto internal surfaces and/or external surfaces. The period length may be in the range of between 0.1 mm-1 mm. The periodical structure can be aligned to achieve scattering in the desired direction.

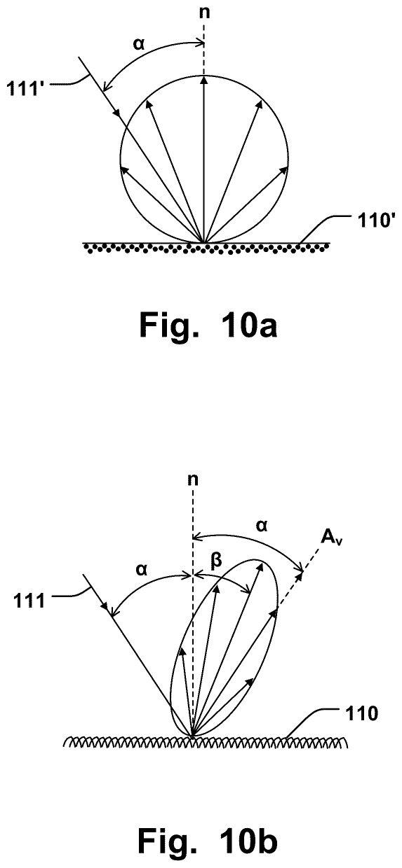

In one example, the diffusive light directing surface 110 typically provide light scattering which is non-Lambertian. FIG. 10b is a schematic illustration of light 111 at an incident angle (a) being reflected against light directing surface 110. The light is spread predominantly, although not necessarily symmetrically, around the optical axis Aᵥ defined by reflecting the incoming optical axis with respect to the average surface normal (n), i.e. what could be called the average specular direction. In order to achieve the spread around the optical axis A_{y}, a surface reflection is utilized. The light spread is controlled by the surface roughness. While metrics like Ra and Rz are common in describing surface roughness, the spread is related to local slopes which are for example measured by RΔq (RMS slope). Increasing the average slope (e.g. increasing RΔq) will thus increase the spread around the optical axis Aᵥ. In addition, the surface roughness may also shift direction of peak reflectivity slightly away from Aᵥ. This is because downhill slopes are shadowed by uphill slopes, making the effective average surface normal tilt a little towards the incoming light. This is mainly seen at high angles of incidence and is the reason why the illustration in FIG. 10b highlights a difference between the direction of peak reflection (angle β) and the optical axis Aᵥ. The diffusive light scattering element 108 may thus provide a light directing surface 110, i.e. a reflector surface 110, which is not an ideal Lambertian diffuser, or close to an ideal Lambertian diffuser. For reference, an ideal Lambertian diffuser would typically redistribute light around the surface normal (n) of the light directing surface 110′, regardless of the incident angle α of the light 111′, as schematically illustrated in FIG. 10a. Lambertian-type diffusers are most often achieved by multiple bulk scattering inside the diffuser material (e.g. white paint, paper or other materials with heterogeneous refractive index).

The diffusive light scattering element 108 may provide a light directing surface 110, i.e. a reflector surface 110, with a total reflectance (total integrated scatter) preferably above 50%.

The spread of light around the optical axis of the emitters 105, 105′, detectors 106, can be controlled by varying the surface properties. For the case of surface reflectors such as sandblasted aluminium, the local slope distribution (as measured by e.g. RΔq) will govern spread: higher slopes will give more spread. The contribution to the light intensity and distribution as exemplified in FIG. 8 from the respective emitters may thus be optimized to the particular touch application. The reflector surface 110 may have a surface roughness with an RΔq larger than 0.1 in some examples. This provides for a useful scan line width which is not too narrow. In some examples the RΔq is within a range that provides for small variations in the scan line width, and thereby small variations in the attenuation of the light during the touch detection process, in turn providing for a more accurate detection of touch events. The RΔq is in the range 0.1-0.25 in one example. An RΔq in this range may provide for a particularly advantageous touch detection.

If low roughness, i.e. low RΔq, is preferred it may in some examples be advantageous to have an inherent good φ-coverage of emitters/detectors, e.g. by having optimized capsule/lens designs, scattering lens material or structured diffusive capsule/lens surface.

The panel 101 may comprise a rear surface 115 opposite the touch surface 102. The emitters 105, 105′, and/or the detectors 106 may be arranged below the rear surface 115, e.g. as schematically illustrated in the examples of FIGS. 1, 6 and 7. The emitters 105, 105′, and/or the detectors 106 may be arranged opposite the rear surface 115 to emit and/or receive light through the panel 101, as schematically illustrated in e.g. FIG. 1. The light directing surface 110 and the emitters 105, 105′, and/or the detectors 106, may be arranged on opposite sides of the panel 101 and overlap in the direction of the plane 103. I.e. an overlap may be provided in the horizontal position of the light directing surface 110 and e.g. the emitters 105, 105′, as exemplified in FIG. 1. This provides for a facilitated control of the angle (v, v₁, v₂) of the optical axis (A) relative the light directing surface 110, and thus an efficient and optimized distribution of light in the plane 103.

The panel 101 may be made of glass, poly(methyl methacrylate) (PMMA) or polycarbonates (PC). The panel 101 may be designed to be overlaid on or integrated into a display device or monitor (not shown). It is conceivable that the panel 101 does not need to be light transmissive, i.e. in case the output of the touch does not need to be presented through panel 101, via the mentioned display device, but instead displayed on another external display or communicated to any other device, processor, memory etc. The panel 101 may be provided with a shielding layer such as a print, i.e. a cover with an ink, to block unwanted ambient light. The amount of stray light and ambient light that reaches the detectors 106 may thus be reduced.

As used herein, the emitters 105 may be any type of device capable of emitting radiation in a desired wavelength range, for example a diode laser, a VCSEL (vertical-cavity surface-emitting laser), an LED (light-emitting diode), an incandescent lamp, a halogen lamp, etc. The emitter 105 may also be formed by the end of an optical fiber. The emitters 105 may generate light in any wavelength range. The following examples presume that the light is generated in the infrared (IR), i.e. at wavelengths above about 750 nm. Analogously, the detectors 106 may be any device capable of converting light (in the same wavelength range) into an electrical signal, such as a photo-detector, a CCD device, a CMOS device, etc.

With respect to the discussion above, “diffuse reflection” refers to reflection of light from a surface such that an incident ray is reflected at many angles rather than at just one angle as in “specular reflection”. Thus, a diffusively reflecting element will, when illuminated, emit light by reflection over a large solid angle at each location on the element. The diffuse reflection is also known as “scattering”. The described examples refer primarily to aforementioned elements in relation to the emitters 105, to make the presentation clear, although it should be understood that the corresponding arrangements may also apply to the detectors 106.

The invention has mainly been described above with reference to a few embodiments. However, as is readily appreciated by a person skilled in the art, other embodiments than the ones disclosed above are equally possible within the scope and spirit of the invention, which is defined and limited only by the appended patent claims.

For example, the specific arrangement of emitters and detectors as illustrated and discussed in the foregoing is merely given as an example. The inventive coupling structure is useful in any touch-sensing system that operates by transmitting light, generated by a number of emitters, across a panel and detecting, at a number of detectors, a change in the received light caused by an interaction with the transmitted light at the point of touch.

1. A touch sensing apparatus comprising:
a panel that defines a touch surface extending in a plane having a normal axis,
a plurality of emitters and detectors arranged along a perimeter of the panel,
a light directing portion arranged adjacent a panel side of the panel, the panel side extending in a longitudinal direction (y) along the perimeter, perpendicular to the normal axis, and
the light directing portion comprising a light directing surface,
wherein the emitters are arranged to emit light and the light directing surface is arranged to receive the emitted light and direct the light across the touch surface, and
wherein an optical axis (A) of the emitted light is at an angle (v, v₁, v₂) from the normal axis so that a vector component (A_{y}) of the optical axis is greater than zero in the longitudinal direction of the panel side.

2. A touch sensing apparatus according to claim 1, wherein an emitter of the plurality of emitters is arranged at said angle (v, v₁, v₂) from the normal axis so that the vector component (A_{y}) of the optical axis is greater than zero in the longitudinal direction.

3. A touch sensing apparatus according to claim 1, wherein the angle (v, v₁, v₂) from the normal axis is defined in the plane spanned by the normal axis and the longitudinal direction.

4. A touch sensing apparatus according to claim 1, wherein the angle (v, v₁, v₂) forms an acute angle with the normal axis.

5. A touch sensing apparatus according to claim 4, wherein the angle (v, v₁, v₂) is in the range 20-45 degrees.

6. A touch sensing apparatus according to claim 1, comprising pairs of emitters arranged side-by-side, the pairs of emitters comprising
a first emitter arranged at a first angle (v₁) from the normal axis, and a second emitter arranged at a second angle (v₂) from the normal axis.

7. A touch sensing apparatus according to claim 6, wherein the first and second angles (v₁, v₂) are the same but oppositely directed with respect to the normal axis.

8. A touch sensing apparatus according to claim 7, wherein the first and second emitters are angled towards each other.

9. A touch sensing apparatus according to claim 6, wherein the first and second angles (v₁, v₂) are different so that the respective vector components (A_{y1}, A_{y2}) of the optical axes (A₁, A₂) in the longitudinal direction are different for the first and second emitters.

10. A touch sensing apparatus according to claim 9, wherein the first and second emitters are angled towards each other.

11. A touch sensing apparatus according to claim 6, wherein the first and second emitters are arranged with a separation gap (d) in the range of 0.1-5 mm.

12. A touch sensing apparatus according to claim 1, wherein a detector of the plurality of detectors is arranged at said angle (v, v₁, v₂) from the normal axis.

13. A touch sensing apparatus according to claim 1, wherein the emitters are mounted on a surface of a substrate, wherein the surface is arranged essentially in the direction of the normal axis.

14. A touch sensing apparatus according to claim 6, wherein the pairs of emitters are mounted to the surface with the respective first and second angles (v₁, v₂) from the normal axis.

15. A touch sensing apparatus according to claim 1, wherein the light directing portion comprises a diffusive light scattering element, and wherein the light directing surface diffusively reflects the light across the touch surface.

16. A touch sensing apparatus according to claim 15, wherein the diffusive light scattering element provides a light directing surface with a total reflectance or total integrated scatter above 50%.

17. A touch sensing apparatus according to claim 15, wherein the diffusive light scattering element has a light directing surface with a surface roughness defined by a slope RMS (RΔq) larger than 0.1.

18. A touch sensing apparatus according to claim 1, wherein the angle (v, v₁, v₂) of the optical axis (A) of light emitted by a first emitter of the plurality of emitters is based on the position (y₁, y₂, y₃) of the first emitter along the longitudinal direction (y) of the panel side.

19. A touch sensing apparatus according to claim 12, wherein the angle (v, v₁, v₂) of the detector is based on the position (y′₁, y′₂, y′₃) of the detector along the longitudinal direction (y) of the panel side.

20. A touch sensing apparatus according to claim 18, wherein the angle (v, v₁, v₂) increases as a distance (d₁, d₂, d₃) between the position (y₁, y₂, y₃) of the first emitter along a first panel side and a second panel side is reduced, wherein the second panel side is arranged perpendicular to the first panel side.

21. A touch sensing apparatus according to claim 19, wherein the angle (v, v₁, v₂) increases as a distance (d₁, d₂, d₃) between the position (y′₁, y′₂, y′₃) of the detector along a first panel side and a second panel side is reduced, wherein the second panel side is arranged perpendicular to the first panel side.

22. A touch sensing apparatus according to claim 18, wherein the emitters along a first panel side are arranged at varying angles (v, v₁, v₂) along the first side so that the emitted light along respective optical axes (A) is directed to at least one common reference point on the panel.

23. A touch sensing apparatus according to claim 22, wherein the common reference point is at the intersection of a second panel side and a third panel side (109″), wherein the second panel side extends perpendicular from the first panel side and the third panel side is opposite and parallel to the first panel side.

24. A touch sensing apparatus according to claim 22, wherein the common reference point is at a mid-point at a third panel side being is opposite and parallel to the first panel side.

25. A touch sensing apparatus according to claim 22, wherein the emitters along a first panel side are arranged at varying angles (v, v₁, v₂) along the first side so that the emitted light from a first group of emitters is directed to a first reference point and the emitted light from a second group of emitters is directed to a second reference point, the first and second reference points being arranged at different positions on the panel.

26. A touch sensing apparatus according to claim 1, wherein the panel comprises a rear surface, opposite the touch surface,
wherein the emitters and/or the detectors are arranged below the rear surface.

27. A touch sensing apparatus according to claim 26, wherein the emitters and/or the detectors are arranged opposite the rear surface to emit and/or receive light through the panel.

28. A touch sensing apparatus according to claim 27, wherein the light directing surface and the emitters and/or the detectors are arranged on opposite sides of the panel and overlap in the direction of the plane.
